(19) United States
(12) Patent Application Publication
(10) Pub. No.: US 2010/0327014 A1
(43) Pub. Date: Dec. 30, 2010

(54) APPARATUS AND METHOD FOR FLUID DISPENSING

(75) Inventors: Kevyn Barry Jonas, Bristol (GB); Geoffrey Mcfarland, Wotton-under-Edge (GB)

Correspondence Address: OLIFF & BERRIDGE, PLC, P.O. BOX 320850, ALEXANDRIA, VA, 22320-4850, US

(73) Assignee: RENISHAW PLC, WOTTON-UNDER-EDGE (GB)

(21) Appl. No.: 12/918,944

(22) PCT Filed: Mar. 17, 2009
(86) PCT No.: PCT/GB09/00717

§ 371 Date: Aug. 23, 2010

Related U.S. Application Data
(60) Provisional application No. 61/064,673, filed on Mar. 19, 2008.

(30) Foreign Application Priority Data
Mar. 18, 2008 (GB) 805023.9

(51) Int. Cl. B67D 7/06

(52) U.S. Cl. 222/1; 222/192

(57) ABSTRACT

An apparatus and method are described for selectively dispensing a fluid on to a substrate. The apparatus including a holder for holding a substrate, such as a non-planar substrate or circuit board. A fluid dispenser for dispensing fluid, such as an adhesive, and a positioning device for moving the fluid dispenser are also provided. The positioning device and fluid dispenser are arranged to allow fluid to be dispensed on to a substrate, held by the holder. The holder including a tilting mechanism that enables a substrate, held by the holder to be tilted about at least one axis. In use, a substrate may be tilted such that the region of the substrate onto which fluid is to be dispensed by the fluid dispenser is at least approximately horizontal thereby preventing unwanted fluid flow under gravity.

The present invention relates to an apparatus and method for dispensing a fluid onto a substrate. In particular, the present invention relates to an apparatus and method for selectively dispensing encapsulant, adhesive, solder paste or the like onto a non-planar substrate.

Apparatus for the automated placement and adhesion of components to a substrate are known. For example, U.S. Pat. No. 6,266,869 describes an apparatus and associated method for assembling various components of a computer hard disk drive. In particular, U.S. Pat. No. 6,266,869 describes an assembly apparatus or robot comprising an arm that can be moved along three orthogonal axes (X, Y and Z). The moveable arm carries a vacuum collet for picking up components, an adhesive dispensing nozzle and an ultraviolet light source for curing deposited adhesive. Trays placed on the flat bed of the apparatus carry a plurality of components that are to be assembled. In use, adhesive is firstly dispensed onto a selected region of a first component using the glue nozzle. A second component is then picked up by the vacuum collet and placed onto the first component in the desired orientation. The adhesive is then cured using UV radiation from the UV light source. In this manner, the various sub-assemblies of the hard drive can be automatically assembled. Although automated assembly apparatus of the type described in U.S. Pat. No. 6,266,869 allows automated assembly of certain components, the capability of such apparatus to assemble complicated structures is limited.

It has also been proposed previously to perform component placement using a Stewart platform or hexapod. For example, DE10055185 describes a technique for placing components on a substrate mounted on a rotatable table using a hexapod. However, in common with U.S. Pat. No. 6,266,869, the ability to perform automated manufacture of complicated components using such apparatus is limited.

According to a first aspect of the present invention, apparatus is provided for selectively dispensing a fluid on to a substrate, the apparatus comprising; a holder for holding a substrate, a fluid dispenser for dispensing fluid, and a positioning device for moving the fluid dispenser, wherein the positioning device and fluid dispenser are arranged to allow fluid to be dispensed on to a substrate held by the holder, characterised in that the holder comprises a tilting mechanism that enables a substrate held by the holder to be tilted about at least one axis.

The present invention thus provides an apparatus for dispensing fluid, such as an encapsulant, adhesive or solder paste, on to a substrate. The positioning device is arranged to move the fluid dispenser so as to bring it in to an operable position relative to the substrate whereupon fluid can be deposited on the selected area or areas of the substrate. In addition, the holder of the present invention comprises a tilting mechanism that permits the absolute orientation of the substrate (i.e. the orientation of the substrate relative to ground) to be defined. In this manner, the apparatus controls the position and orientation of the substrate relative to the fluid dispenser and also controls the absolute orientation of the substrate.

The apparatus of the present invention thus provides control over multiple degrees of freedom between the fluid dispenser and the substrate. However, unlike prior art devices of the type mentioned above, the provision of a holder that allows tilting of the substrate means that the substrate can be placed in different absolute orientations, or even moved, during fluid deposition operations. This has been found to provide the advantage of allowing control over the flow of fluid, especially lower viscosity fluid, dispensed on to a substrate and is particularly advantageous when using multi-faceted, freeform or non-planar substrates. Advantageously, the apparatus may be arranged to appropriately orientate a substrate held by the holder to ensure that a localised region onto which fluid is to be dispensed is at least approximately horizontal. In particular, the apparatus is preferably configured such that, in use, the tilting mechanism orientates the holder so as to minimise, or substantially prevent, the flow of fluid on the surface of the substrate under the action of gravity. In other words, the tilting of the substrate preferably prevents any flowing of the fluid deposited on that region (e.g. due to gravity). Furthermore, as explained in more detail below, the ability to control absolute substrate orientation is also advantageous if components are subsequently attached to the substrate using the dispensed fluid. For example, appropriate orientation of the substrate can also ensure that components do not shift in position (e.g. due to gravity) after being placed on solder paste or adhesive deposited on the substrate but prior to that adhesive or solder paste being cured. Tilting the substrate in addition to moving the fluid dispensing device also provides improved access to certain regions or features of the substrate compared with moving the fluid dispensing device alone.

The present invention thus provides improved apparatus for use in automated fluid deposition processes and is particularly suited for use in processes that involve depositing an encapsulant, adhesive or solder paste onto a substrate. Apparatus of the present invention thus allows the automated production of complex devices, such as three dimensional devices or the like that are constructed by mounting various components on a non-planar substrate. This is thus a significant improvement over known methods in which fluids and components had to be manually placed on such non-planar devices. Apparatus of the present invention thus extends the various benefits of automated or semi-automated assembly processes, such as speed, accuracy, repeatability, reduced cost etc, to a whole new range of more complicated products.

Advantageously, the holder comprises a tilting table having a table base and a tiltable table top, wherein a substrate can be releaseably retained on the tiltable table top. The substrate may be held on the table top in a variety of ways; for example, clips, clamps, screws, a vacuum chuck, a vacuum bed or other retaining means may be provided. Advantageously, the retaining means is automated so that the substrate can be held and released as necessary under control of the apparatus.

The tilting mechanism of the holder allows a retained substrate to be tilted about one or more axes. For example, the table top on which the substrate is held may be tilted away from the horizontal. Advantageously, the tilting mechanism allows the substrate to be tilted about two or more axes. The substrate may be tiltable from the horizontal by more than 10°, by more than 45° or by more than 90°. The holder may also provide additional movement of the substrate. For example, the holder may also allow the substrate to be translated along one or more axes (e.g. moved “up and down”) or rotated about a vertical axis.

The apparatus of the present invention is particularly suited for dispensing a fluid on to a non-planar substrate. Advantageously, the holder may be holding the non-planar substrate. The term non-planar substrate as used herein encompasses any substrate that is not flat but has some kind of three dimensional shape; the term thus includes objects having one or more freeform or curved surfaces and objects having a plurality of faces or facets that are located in different planes or have different surface normals. For example, a non-planar substrate may include a cubic or cuboidal substrate or a substrate formed from a curved or bent sheet of material. Conveniently, the non-planar substrate comprises a substrate having two or more component mounting surfaces; each of the two or more component mounting surfaces having different surface normals. Advantageously, the non-planar substrate comprises a substrate having three or more component mounting surfaces. Examples of non-planar substrates include the moulded plastic casings or housings of electronic devices. Advantageously, the holder of the apparatus of the present invention is arranged to hold such a non-planar substrate. Such a holder may be a general purpose holder or it may be fabricated to hold a specific type or kind of non-planar substrate as necessary.

It should be noted that the present invention also offers various advantages when dispensing fluid onto planar substrates. For example, the ability to tilt the substrate gives improved access to certain substrate features, such as overhangs or holes formed at oblique angles relative to the substrate surface. Furthermore, apparatus of the present invention can be conveniently used to deposit fluid onto a (planar or non-planar) substrate that is subsequently folded (optionally using the apparatus of the present invention).

As outlined above, the positioning device of the apparatus moves the fluid dispenser about in space and in particular moves the fluid dispenser in to an operable, or fluid dispensing, position relative to a substrate held by the holder. The positioning device may thus translate and/or rotate the fluid dispenser as required. In other words, the positioning device may control any one or more of the six degree of freedom of movement of the fluid dispenser. Advantageously, the positioning device provides translational movement of the fluid dispenser along a plurality of axes. For example, the positioning device may be operable to translate the fluid dispenser along two mutually orthogonal (X, Y) axes or along three mutually orthogonal (X, Y, Z) axes. The positioning device may also provide rotational movement of the fluid dispenser about one or more axes. For example, the positioning device may be arranged to rotate the fluid dispenser about one, two or three axes.

At this point, it should be noted that the fluid dispenser moved by the positioning device may merely comprise a nozzle, nozzles or the like through which fluid is expelled. The fluid dispenser may thus form a part of a fluid dispensing system that also includes further parts (e.g. a fluid reservoir, pump, supply tubes etc). These additional parts of the fluid dispensing system are not necessarily mounted to or moved by the positioning device. For example, the positioning device may move a fluid dispensing nozzle around in three dimensions, the nozzle being connected by a length of flexible tubing to a pump and reservoir located on a stationary part of the apparatus.

The positioning device may comprise any type of robot or positioning machine. The positioning machine may have a fixed base and a moveable mount to which the fluid dispenser is mounted. The positioning device may comprise a positioning machine having a so-called Cartesian configuration in which a movable mount is supported for movement relative to a base with three translational degrees of freedom by means of three serially mounted (i.e. one on top of another), mutually orthogonal linear guideways. Advantageously, the positioning device comprises a non-Cartesian or parallel positioning machine in which the moveable mount is attached to the base by plurality of extendable legs. The parallel positioning machine may comprise a hexapod or Stewart platform having six extendable legs linking the base to the moveable mount and thereby controlling all six degrees of freedom between the base and the mount. Conveniently, the parallel positioning machine includes a constraining mechanism that constrains at least one of the degrees of freedom between the base and the moveable mount. In a preferred embodiment, a parallel positioning machine is provided in which all rotational degrees of freedom between the base and the moveable mount are constrained. In such an arrangement, three extendable legs provide control over the relative position of the base and moveable mount and a plurality of fixed lengths legs prevent any rotation. Examples of such a constrained parallel positioning machine are described in EP1612506 and U.S. Pat. No. 7,241,070, the contents of which are incorporated herein by reference. Parallel positioning machines are preferred, but are by no means essential, as they have various advantages in terms of speed of motion, cost of construction and access compared with serial positioning machines.

As outlined above, apparatus of the present invention provides relative motion between the fluid dispenser and a substrate held by the holder by moving both the substrate and the fluid dispenser. Advantageously, the apparatus provides at least four axes of relative motion between a substrate held by the holder and the fluid dispenser. Conveniently, the apparatus may provide at least five axes of relative motion between a substrate held by the holder and the fluid dispenser. In this manner, the apparatus provides control over at least four, at least five or all six of the six degrees of freedom of movement between a substrate held by the holder and the fluid dispenser. For example, the positioning device may translate the fluid dispenser along two or three axes and the holder may allow a substrate to be tilted about one or two axes.

The fluid dispenser may be arranged to dispense any type or types of fluid. The fluid dispenser may comprise a single nozzle or outlet for dispensing a fluid or liquid. Alternatively, the fluid dispenser may comprise a plurality of nozzles or outlets for dispensing a plurality of different fluids or liquids. It should also be noted that, herein, the term fluid takes the meaning well known to those skilled in the art of being any non-solid material that flows or is composed of particles that can move about with freedom. The term fluid thus includes pastes (e.g. solder paste), colloid suspensions, gels, liquids, solvents and inks etc. Advantageously, the fluid dispenser is arranged to dispense an adhesive or encapsulant. The fluid dispenser may thus be a glue or adhesive dispenser. The adhesive dispensed by the adhesive dispenser may be uncured or partially cured prior to being dispensed.

The fluid dispensed by the fluid dispenser may provide, when located on the substrate, a passive electrical function; e.g. it may permit a solder joint, a conductive track or an insulating region to be formed. Alternatively, the fluid may provide an active electrical function thereby allowing various electronic components to be built up on the substrate by the deposition of layers or regions of appropriate fluid. For example, liquid (e.g. organic) semiconductor material may be dispensed onto the substrate along with various insulating and conductive fluids. In this manner, semiconductor devices such as LEDs, photodetectors, transistors, diodes etc may be formed. In other words, the deposited fluid(s) may provide so-called plastic electronic circuitry.

The fluid dispenser may conveniently dispense a solvent. The solvent may be used to dissolve a previously dispensed adhesive or other material and can thus be advantageously used in a process of removing components from a substrate. The apparatus of the present invention can thus be used for both fabrication and disassembly (including rework) purposes.

The apparatus may comprise an activation source, such as a source of heat and/or radiation, for locally activating fluid deposited by the fluid dispenser. The activation source is preferably directional so that only the selected local area of the substrate is activated without affecting surrounding areas of the substrate. The type of activation source is conveniently selected to activate the particular fluid that is deposited by the fluid dispenser. The activation source may be a contact heat source, such as a heated tip, that is brought into contact with the fluid and/or the substrate. Advantageously, the activation source is a (non-contact) radiation source that activates the fluid; for example, an ultraviolet (UV) light source, a laser, an acoustic source or a microwave radiation source may be provided. Advantageously, a focussed beam of radiation is emitted by the activation device. The activation source may thus cure a deposited adhesive or melt a deposited solder paste. It should also be noted that activation of a fluid using the activation source may provide or block an effect. For example, a so-called positive process may be used in which fluid is activated to provide a certain function (e.g. to form a conductive track, provide a solder connection etc). Alternatively, a negative process may be employed in which any activated fluid does not provide a function; e.g. activated fluid may be easily removed during a subsequent process step that has no effect on any unactivated fluid.

The activation source is advantageously moved by the positioning device. For example, the fluid dispenser and activation source may both be mounted so as to move with a moveable mount, platform or head of the positioning device. It should be noted that the activation source may form part of an activation system that includes other components (e.g. a power supply, controller etc) that are not moved by the positioning device. For example, the positioning device may move an activation source that comprises the distal end of an optical fibre. In such an example, the proximal end of the optical fibre may be coupled to a stationary laser. Furthermore, the activation source may comprise a heatable tip that is coupled to a stationary electrical power control system via an electrical cable.

In a preferred embodiment, the activation source comprises an open ended microwave cavity; e.g. a frequency agile open ended microwave cavity. Advantageously, the activation source is a Frequency Agile Microwave Oven Bonding System (FAMOBS) of the type described in K. I. Sinclair et al, Proc. IEEE Electronics System Integration Technology Conference 2006, Vol. 2, pp 1149-1157 and T. Tilford et al, 41^{st} Annual Microwave Symposium Proceedings of the International Microwave Power Institute, Aug. 1-3, 2007, the contents of which are incorporated herein by reference. The use of a FAMOBS heat source is particularly advantageous as it can be tuned so as to heat a fluid through a component (e.g. to provide sub-surface curing) thereby reducing the amount of machine movement that is required during the place and cure operations.

Advantageously, the apparatus comprises a component pick-up device such as a vacuum nozzle or other gripping means. The component pick-up device may be arranged to pick up components and then place such components on a substrate held by the holder. It should be noted that placing a component as described herein may involve the component pick-up device bringing the component into direct contact with the substrate or projecting (e.g. firing/launching) the component across a gap so as to land on the substrate in the required position and orientation. Conveniently, at least one of an electrical, optical and electro-optic component is picked up by the pick-up device. The component pick-up device is preferably moved by the positioning device. For example, the fluid dispenser, activation source and component pick-up device may all be mounted so as to move with a moveable mount of the positioning device. As outlined in more detail below, such apparatus may be used to deposit adhesive on to the substrate, place the component in the adhesive and cure the adhesive to fix the component in place on the substrate. The component pick-up device may also be used to remove components from a substrate held by the holder during a disassembly process. Advantageously, the pick-up device allows the component to be rotated to provide the required alignment between the component and the substrate; e.g. the pick-up device may be rotated by the positioning apparatus to appropriately align the component relative to the substrate.

Preferably, the apparatus is operated under the control of a computer. Advantageously, a position feedback system is provided for sensing the position of a substrate held by the holder relative to the fluid dispenser during the fluid deposition process. The position feedback system may comprise position encoders or the like that form part of the positioning device and/or the tilting mechanism and thus provide appropriate position and orientation information. The position feedback system may also include an image or video recognition system (e.g. comprising one or a plurality of video cameras) for determining the position and/or orientation of the substrate relative to the fluid dispensing device. In this manner, a feedback control loop may be provided to ensure the required pattern of fluid is laid down on the substrate. Such an image recognition system may also be used for component placement; e.g. the orientation of a component picked up by the pick-up device relative to the substrate can be determined in order to ensure placement accuracy. Similarly, the position of an activation source relative to the substrate could also be determined in a similar manner.

The fluid dispenser may, in use, be permanently attached to the positioning device. For example, the fluid dispenser may be bolted or welded to a moveable platform of the positioning device. Similarly, any activation source and/or component pick-up device may, in use, be permanently attached to the positioning device. Advantageously, the fluid dispenser is, during use, releasably attachable to the positioning device. For example, a releasable connector (e.g. a magnetised kinematic mount) or clamp may be used to attach the fluid dispenser to the positioning device. In this manner, the fluid dispenser may be attached to the positioning device only when fluid deposition is required. Conveniently, the releasable connector allows the fluid dispenser to be automatically detached from the positioning device (e.g. without the need for a technician to remove a bolt) when an appropriate control instruction is issued by the computer control system. In the times between fluid deposition, the positioning device may carry other devices, such as an activation source or a pick-up device. A rack may be conveniently provided for storing the fluid dispenser, and any activation source or pick-up device, when not attached to the positioning device.

According to a second aspect of the invention, a method is provided for dispensing a fluid on to a substrate using apparatus having a moveable fluid dispenser and a holder for holding a substrate, the method comprising the steps of; (i) mounting a substrate to the holder, and (ii) bringing the fluid dispenser in to an operative position relative to the substrate and using the fluid dispenser to dispense a fluid on to the substrate, wherein step (ii) comprises moving the fluid dispenser and is characterised by the step of also tilting the substrate about at least one axis. As outlined above, tilting the substrate provides various advantages when depositing a fluid.

Advantageously, step (ii) comprises the step of tilting the substrate such that the region of the substrate onto which fluid is dispensed is at least approximately horizontal. Conveniently, the substrate is tilted during step (ii) so as to minimise, or substantially prevent, the flow of fluid on the surface of the substrate under the action of gravity.

Advantageously, the apparatus further comprises a pick-up device and the method comprises the additional step (iii) of using the pick-up device to place a component in a fluid dispensed onto the substrate. Step (iii) may also comprise the step of actively aligning the component and the substrate. For example, a video based alignment system may be used.

Conveniently, the apparatus further comprises an activation source as described above and the method comprises the additional step (iv) of using the activation source to activate the fluid dispensed on to the substrate. Advantageously, step (ii) comprises using the fluid dispenser to dispense an adhesive on to the substrate and step (iv) may then comprise using an activation source to cure the adhesive. Step (ii) may alternatively or additionally comprise using the fluid dispenser to dispense a solder paste on to the substrate in which case step (iv) may comprise using an activation source to melt the solder paste.

Advantageously, the activation source is a microwave source and step (iv) comprises directing microwave radiation at the fluid. Step (iv) may thus comprise activating a dispensed fluid to form conductive pathways or tracks or other marks. For example, a colloid comprising metal ions in a dispersion medium may be heated by the microwave source to form a conductive track. Advantageously, step (iv) comprises curing fluid on which a component has been placed thereby activating (e.g. curing an adhesive or melting a solder paste) the fluid and securing the component in place. Advantageously, the activation source is highly directional or focussed to minimise any heating of surrounding regions of the substrate. Preferably, the activation source is a FAMOBS device of the type described above.

Advantageously, step (ii) comprises tilting the substrate into a first orientation. The fluid dispenser may then be moved so as to dispense fluid onto a first region of the substrate. Step (ii) may then be repeated one or more times. Conveniently, during each repetition of step (ii), the substrate is tilted into a further orientation and the fluid dispenser dispenses fluid on to a further region of the substrate. If step (ii) is performed a plurality of time, either or both of the above described steps (iii) and (iv) may be performed between repetitions of step (ii).

In a preferred embodiment, step (i) may comprise taking a non-planar substrate. For example, a non-planar circuit module substrate. Electronic components may then be attached to differently orientated surfaces or faces of such a substrate using the above described method.

The invention will now be described, by way of example only, with reference to the accompanying drawings in which;

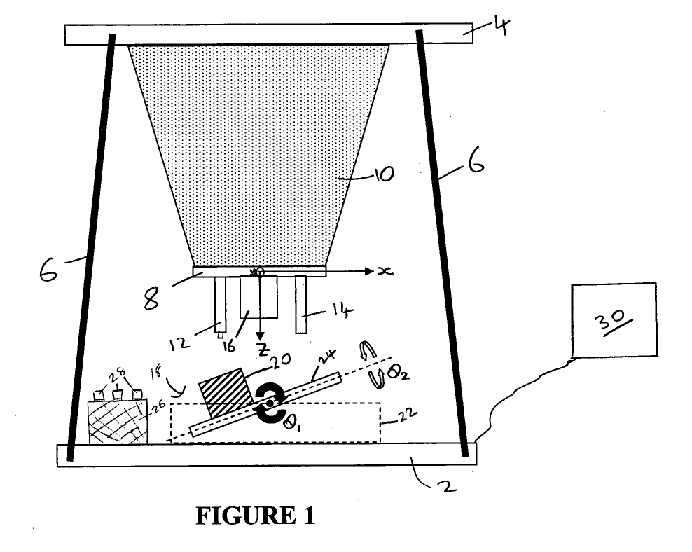

FIG. 1 illustrates an embodiment of the apparatus of the present invention,

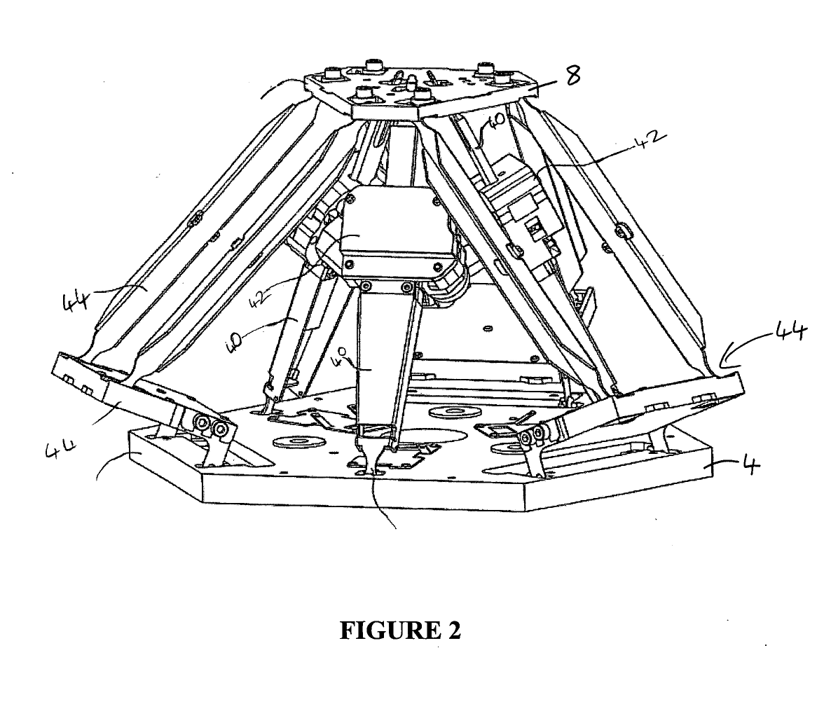

FIG. 2 shows the parallel positioning device of the apparatus of FIG. 1 in more detail,

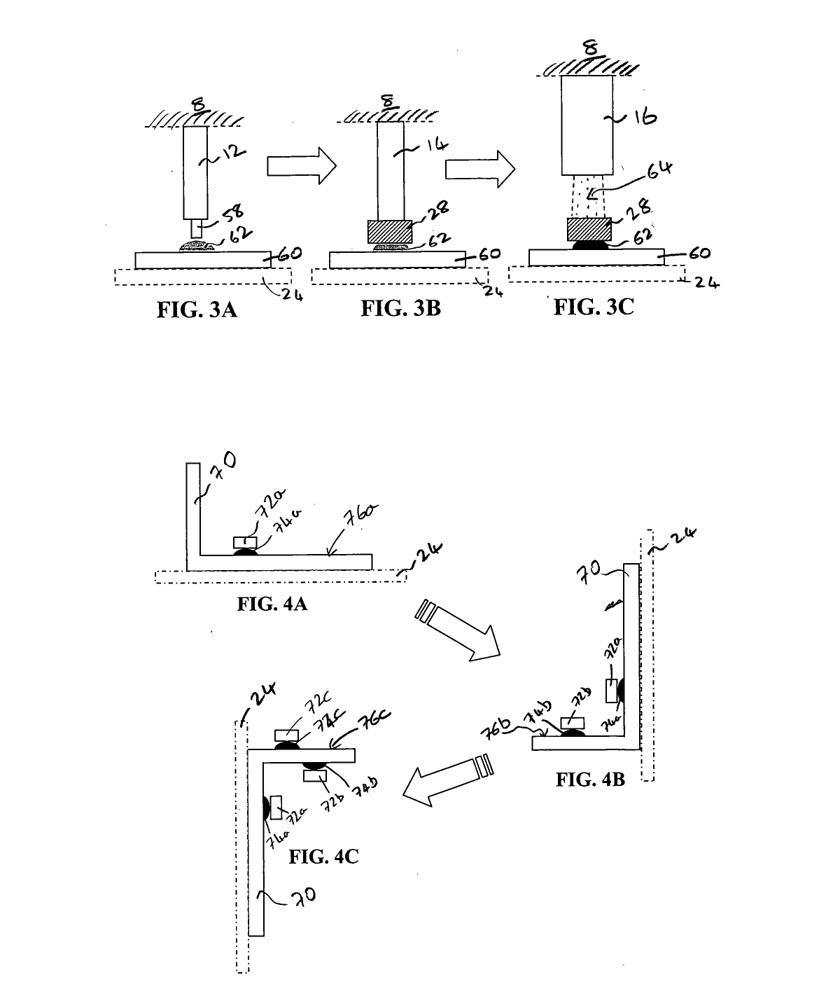

FIGS. 3a-3c illustrates a technique for attaching components to a substrate using apparatus of the type shown in FIGS. 1 and 2,

FIGS. 4a-4c show component placement on an L-shaped substrate using apparatus of the type shown in FIGS. 1 and 2,

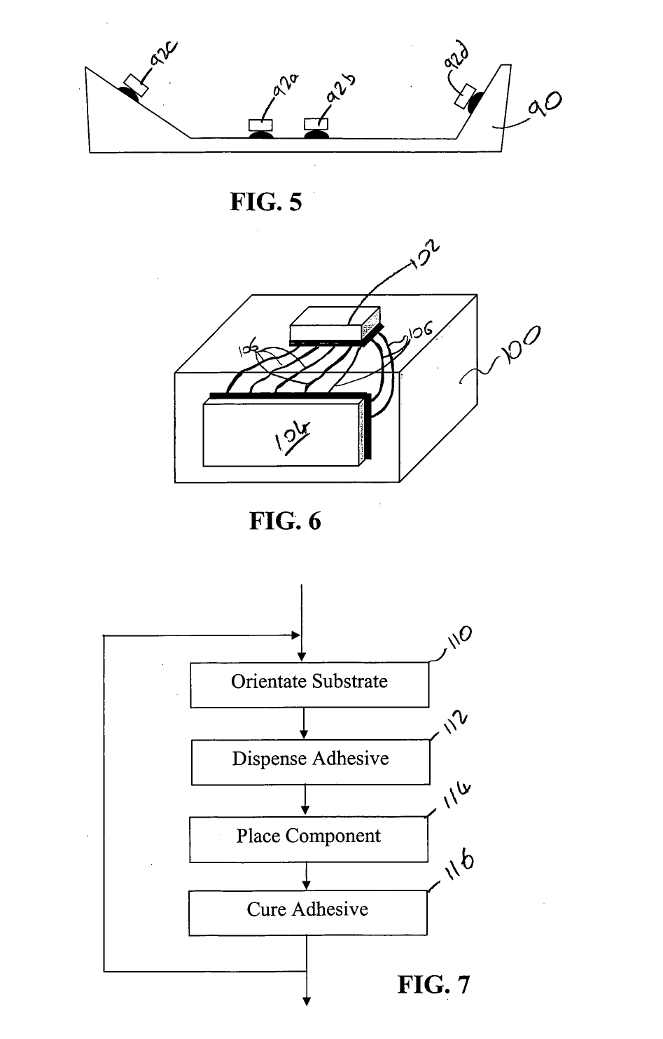

FIG. 5 shows component placement on an U-shaped substrate using apparatus of the type shown in FIGS. 1 and 2

FIG. 6 shows component placement on an cuboidal substrate using apparatus of the type shown in FIGS. 1 and 2, and

FIG. 7 is a flow diagram outlining the steps of a method according to the present invention.

Referring to FIG. 1, apparatus of the present invention is illustrated.

The apparatus comprises a bed 2 fixed to an upper or base platform 4 by a plurality of support struts 6. The support struts 6 are sufficiently rigid to ensure the base platform 4 is held in a fixed position relative to the bed 2. The base platform 4 is also attached to a moveable platform 8 by a constrained parallel kinematic positioning mechanism 10. For clarity, details concerning the parallel kinematic positioning mechanism 10 are omitted from FIG. 1 and the mechanism is shown in detail in FIG. 2. The base platform 4, moveable platform 8 and parallel kinematic positioning mechanism 10 thus form a constrained parallel positioning machine that controls translational movement of the moveable platform 8 along three axes (X, Y, Z). The moveable platform 8 has a fluid dispensing device 12, a pick-up device 14 (e.g. a vacuum based pick-up device) and a FAMOBS device 16 mounted thereon. The fluid dispensing device 12 is connected to a remote fluid pump and reservoir via a fluid supply tube (not shown). In this example, the fluid dispensing device 12 is arranged to dispense a conductive adhesive paste but it should be noted that it may be used to dispense any type of fluid.

The moveable platform 8 shown FIG. 1 has the fluid dispensing device 12, the pick-up device 14 (e.g. a vacuum based pick-up device) and the FAMOBS device 16 all mounted thereon. This is, however, not essential. It would also be possible for the moveably platform 8 to include a mount for receiving any one of the fluid dispensing device 12, the pick-up device 14 (e.g. a vacuum based pick-up device) and the FAMOBS device 16 at any one time. In other words, the appropriate device could be mounted to the moveable platform 8 as and when required; the remaining devices could then be stored in a rack or placed in a storage area until they are needed.

Also mounted to the bed 2 of the apparatus is a holder 18 for holding a substrate 20. The holder 18 comprises a table base 22 and a table top 24 that can be tilted relative to the table base 22 about two orthogonal axes of rotation (θ₁ and θ₂). Such rotary movement may be provided by two serially mounted rotational stages. The table top 24 also comprises a clamp (not shown) for holding a substrate 20 placed thereon. The holder 18 thus provides a tilting mechanism that allows the absolute orientation of the substrate (i.e. the substrate orientation relative to the ground or, more importantly, relative to gravity) to be set. A component storage area 26 is also provided on the bed 2 for storing various components 28 prior to use.

A computer 30 is provided for controlling operation of the apparatus. In particular, the computer 30 controls motion of the moveable platform 8, the orientation of the substrate as defined by the holder 18, the dispensing of fluid from the fluid dispensing nozzle 12, operation of the pick-up device 14 and activation of the FAMOBS device 16. One or more video cameras (not shown) may also be provided that feed images back to the computer 30 that give information about the position of the apparatus relative to the substrate 20. Methods of using such apparatus are described in detail below.

Referring to FIG. 2, the constrained parallel positioning machine used in the apparatus of FIG. 1 will be described in more detail; noting that the illustration of the constrained parallel positioning machine given in FIG. 2 is inverted (i.e. upside down) compared with the view of FIG. 1.

The constrained parallel positioning machine comprises a base platform 4 that is mounted to a moveable platform or stage 8 by a plurality of struts. In particular, the base and moveable platforms 4 and 8 are linked by three powered telescopic struts 40, the ends of which are connected to the platforms by pivot joints. Each powered telescopic strut 40 has a motor 42 to increase or decrease its length and a position encoder (contained within the motor housing and therefore not visible in FIG. 2) to measure its length. Three anti-rotational devices 44 are also provided to constrain the three rotational degrees of freedom between the base platform 4 and the moveable platform 8; the anti-rotational devices are passive and comprise no motor or other type of actuator. Extension of the powered telescopic struts 40 of the machine thus provides only translational (not rotational) movement between the base platform 4 and the moveable platforms 8. In other words, the moveable platform 8 can be translated in space relative to the fixed based platform 4 and such translation may be described in terms of movement along X, Y and Z axes.

Although the apparatus shown in FIGS. 1 and 2 comprises a constrained parallel positioning machine, it should be remembered that any type of positioning machine could be used. The positioning machine could include a serial or parallel mechanism as described above. The constrained parallel positioning mechanism and the holder 18 together provide positioning apparatus for moving the substrate relative to the moveable platform 8.

Referring to FIGS. 3a to 3c, the attachment of a component to a substrate using apparatus of the type described with reference to FIGS. 1 and 2 is illustrated.

FIG. 3a illustrates a first step in the process in which a nozzle 58 of the fluid dispensing device 12 is brought in to a fluid dispensing position relative to a substrate 60 mounted on the table top 24 of the holder 18. The necessary motion of the fluid dispensing device 12 is provided by movement of the moveable stage 8 of the apparatus. The required pattern of conductive adhesive 62 is then deposited on the substrate. This first step may, optionally, include monitoring the position of the nozzle 58 relative to the substrate 60 (e.g. using a video camera based image recognition system) to ensure the required pattern of adhesive is provided. Although only a single region or drop of adhesive is shown in FIG. 3a for clarity, it should be noted that a more complex adhesive pattern (e.g. corresponding to desired points of electrical connection with an electronic chip etc) may be laid down by the fluid dispensing device 12. Once the required pattern of adhesive has been deposited, the fluid dispensing device 12 is withdrawn from the substrate.

FIG. 3b illustrates a second step in the process in which a component 28 that has been picked up from the component storage area 26 by the pick-up device 14 is placed on the conductive adhesive 62. Again, motion of the pick-up device 14 is provided by movement of the moveable stage 8 of the apparatus. This second step may, optionally, include an active alignment step in which the orientation and position of the component 28 is monitored (e.g. using a video camera based image recognition system) thereby ensuring accurate placement. Once placed, the pick-up device 14 releases the component 28 and is withdrawn thus leaving the component 28 loosely attached to the substrate 60 via the uncured adhesive.

FIG. 3b illustrates a third step in which the moveable stage 8 moves the FAMOBS device 16 into proximity with the substrate 60. This third step may, optionally, include monitoring the position of the FAMOBS device 16 relative to the substrate 60 (e.g. using a video camera based image recognition system). As outlined above, a FAMOBS device emits microwave radiation of varying frequency and can be arranged to cause heating in certain materials (e.g. an adhesive or solder paste) whilst causing no significant heating in other materials (e.g. semiconductor materials used to form electronic components). It is thus possible, using a FAMOBS device, to cure an adhesive by directing the emitted microwave radiation onto that adhesive through a component. The FAMOBS device 16 is thus orientated by the moveable stage 8 so that it directs microwave radiation 64 into the conductive adhesive 62 through the component 28. The adhesive is thus cured without any damage to the component 28 and without having to provide a direct line of sight between the FAMOBS device 16 and the conductive adhesive 62. Once the conductive adhesive 62 is cured, the FAMOBS device 16 is withdrawn and the component 28 is securely attached to the substrate.

The above described apparatus may be used to attach components to planar substrates, such as a printed circuit board (PCB), but is particularly advantageous when using non-planar substrates. In particular, the above described apparatus facilitates the attachment of components to non-planar substrates thereby allowing three dimensional or non-planar circuit module to be formed.

Referring to FIGS. 4a-4c, a method is outlined for attaching components 72a, 72b and 72c to three mounting faces 76a, 76b and 76c of an L-shaped (non-planar) substrate 70 using the above described apparatus.

FIG. 4a shows an L-shaped substrate 70 retained on the tiltable table top 24 of the holder 18 with the tiltable table top 24 placed in a first orientation. The first orientation of the tiltable table top 24 is selected so that first mounting face 76a is substantially horizontal. A first electronic component 72a is mounted to the first mounting face 76a by conductive adhesive 74a using the steps described above with reference to FIG. 3.

At this point is should also be noted that the orientation of the mounting face need not be accurately horizontal. A certain amount of tilt of the surface away from horizontal is typically acceptable and the amount of tilt will depend on various factors, such as the viscosity of the uncured adhesive and the weight of the component.

After the first electronic component 72a has been attached to the first mounting face 76a, the tiltable table top 24 is moved into a second orientation as shown in FIG. 4b in which the second mounting face 76b is substantially horizontal. A second electronic component 72b is mounted to the second mounting face 76b by conductive adhesive 74b using the steps described above with reference to FIG. 3.

After the second electronic component 72b has been attached to the second mounting face 76b, the tiltable table top 24 is moved into a third orientation as shown in FIG. 4c in which the third mounting face 76c is substantially horizontal. A third electronic component 72c is mounted to the third mounting face 76c by conductive adhesive 74c, again using the steps described above with reference to FIG. 3.

This process may be continued until all the required components have been mounted to the L-shaped substrate 70 thereby forming the required circuit module. It should be noted that although the attachment of a single component to each mounting face is described, any number of components could be attached to each mounting face. Similarly, components could be attached to further faces of the L-shaped substrate 70 if required. An analogous process could also be used for attaching components to a continuously varying surface (e.g. a curved substrate); e.g. a substrate orientation could be selected that allows a subset of the components to be attached to part of the substrate before re-orientating the substrate. Furthermore, tilting about two axes (instead of the one axes shown in FIG. 4) could be implemented when using substrates having a more complex shape.

The process illustrated in FIG. 4 has been found to be particularly advantageous for forming three-dimensional electronic circuit modules from non-planar substrates that can form part of the casing of an electronic device.

Referring to FIG. 5, a portion of plastic casing 90 of an electronic device is shown. The plastic casing 90 has three internal mounting surfaces 92a-92c onto which four electronic components 92a-92d (e.g. electronic chips or other components) are mounted. The electronic components 92a-92d have been attached to each of the mounting surfaces 92a-92c in turn in the manner described with reference to FIG. 4. In particular, the plastic casing 90 would have orientated during fabrication so that each mounting surface was, in turn, held substantially horizontal for component attachment thereto. Various conductive tracks (not shown) can also be deposited on the plastic casing 90 to interconnect the various electronic components; these may be formed integrally with the casing or deposited using the fluid dispensing device 12 of the apparatus.

It can thus be seen that the present invention permits an electronic circuit to be formed on the various internal surfaces of the plastic casing 90. Such non-planar circuit modules have been proposed previously and provide various advantages (e.g. robustness and compactness) over traditional devices that are formed from planar or flexible electronic circuit boards located within a casing. Non-planar circuit modules are not, however, widely used at present because of the necessity to attach the various components to the substrate by hand. The apparatus described herein offers, for the first time, the ability to form such non-planar circuit modules using a totally automated assembly and attachment process. In other words, the present invention permits the fabrication of non-planar circuit modules to be automated thereby greatly reducing the cost of fabricating such circuit modules.

Referring to FIG. 6, a further non-planar substrate in the form of a cuboid 100 is illustrated. Components 102 and 104 may be attached to faces of the cuboid 100 in turn using the above described apparatus. Again, the holder of the apparatus can be used to tilt the cuboid 100 during assembly so that the required face (i.e. the face to which the component is to be mounted) is held substantially horizontal during the process of dispensing the adhesive, attaching the component and curing the adhesive. A colloidal fluid comprising a suspension of metal ions in a dispersing medium may also be dispensed using the fluid dispenser along multiple paths between the components 102 and 104. The colloidal suspension can then be heated by the FAMOBS device to evaporate the dispersing medium of the colloid leaving the required pattern of metal tracks 106 deposited on the substrate and thereby electrically linking the components 102 and 104. In this manner, a circuit may be constructed on all or some of the faces of the cuboid and it would be recognised that such a technique could be used to attach components to any regular or irregular three-dimensional object. Such an object may have discrete faces and/or may comprise curved or bent surfaces.

Referring to FIG. 7, the steps of a method of using the apparatus described above with reference to FIGS. 1 and 2 is illustrated. In a first step 110 the substrate is placed in the required orientation by the holder 18. A second step 112 of dispensing an adhesive (e.g. a conductive adhesive) is performed. The second step 112 may involve dispensing such adhesive to one or more regions on the substrate. A third step 114 of placing one or more components in the adhesive is then carried out, before a fourth step 116 of curing the adhesive is performed. The second, third and fourth steps may involve moving the fluid dispensing device 12, the pick-up device 14 and the FAMOBS device 16 respectively by moving the moveable platform 8 and, optionally, the holder may be used to provide motion of the substrate during any or all of these steps. The whole process may then be repeated and, in particular, the first step 110 may involve re-orientating (tilting) the substrate to provide access to a further mounting face.

The methods outlined with reference to FIGS. 3 to 7 are described as being implemented using apparatus of the type illustrated in FIGS. 1 and 2. In other words, it is described in detail above how the various methods may be implemented using one piece of apparatus that carries a fluid dispenser, a component pick-up device and a FAMOBS device. It should, however, be noted that such methods could also be implemented using a series of single function machines. For example, a substrate could be passed from a first machine that carries a fluid dispenser to a second machine that carries a component pick-up device to a third machine that carries a FAMOBS device. In this manner, the fluid deposition, component placement and FAMOBS heating may be performed in series using different machines.

The above examples describe the deposition of a conductive adhesive onto a substrate. It should, however, be noted that any fluid or even a plurality of different fluids could be dispensed by the apparatus. For example, a solder paste could be dispensed that is activated (melted) by the FAMOBS device. The dispensed fluid also need not be used for attaching a component to the substrate. For example, an ink, a semiconductor material (e.g. an organic semiconductor) or a conductive material (e.g. in colloidal form) could be deposited. The deposited fluid could then perform some required function, such as form part of an electronic circuit. For example, conductive tracks could be laid on a substrate or semiconductor devices could be built on the substrate.

Furthermore, although the above apparatus includes a FAMOBS device, it should be noted that other types of activation device may be provided. For example, a UV curing source or a contact heater may be used. It is, however, preferable that the activation device provides controlled or localised action; e.g. that it can be directed to a specific region of fluid to overcome any unwanted effects associated with heating large areas of the substrate or exposing large areas of the substrate to radiation.

1. Apparatus for selectively dispensing a fluid on to a substrate, comprising;
a holder for holding a substrate,
a fluid dispenser for dispensing fluid, and
a positioning device for moving the fluid dispenser,
wherein the positioning device and fluid dispenser are arranged to allow fluid to be dispensed on to a substrate held by the holder, wherein the holder comprises a tilting mechanism that enables a substrate held by the holder to be tilted about at least one axis.

2. An apparatus according to claim 1, wherein, in use, a substrate held by the holder is orientated by the tilting mechanism such that the region of the substrate onto which fluid is to be dispensed by the fluid dispenser is at least approximately horizontal.

3. An apparatus according to claim 1 wherein the positioning device comprises a parallel positioning machine.

4. An apparatus according to claim 1, the apparatus providing at least five axes of relative motion between a substrate held by the holder and the fluid dispenser.

5. An apparatus according to claim 1 wherein the holder comprises a tilting table having a table base and a tiltable table top, wherein a substrate can be releaseably retained on the tiltable table top.

6. An apparatus according to claim 1 wherein the tilting mechanism of the holder allows a substrate to be tilted about two or more axes.

7. An apparatus according to claim 1 wherein the holder is arranged to hold a non-planar substrate.

8. An apparatus according to claim 1 wherein the fluid dispenser is arranged to dispense an adhesive, encapsulant or solvent.

9. An apparatus according to claim 1 further comprising an activation source for locally activating fluid deposited by the fluid dispenser, the activation source comprising a source of heat and/or radiation, wherein the activation source is moved by the positioning device.

10. An apparatus according to claim 9 wherein the activation source comprises an open ended microwave cavity.

11. An apparatus according to claim 1 further comprising a component pick-up device, the component pick-up device being arranged to pick up components and place such components on a substrate held by the holder, wherein the component pick-up device is moved by the positioning device.

12. An apparatus according to claim 11 wherein the components comprise at least one of an electrical, optical and electro-optic component.

13. An apparatus according to claim 1 wherein the fluid dispenser is releasably attachable to the positioning device.

14. A method for dispensing a fluid on to a substrate using apparatus having a moveable fluid dispenser and a holder for holding a substrate, the method comprising the steps of
(i) mounting a substrate to the holder, and
(ii) bringing the fluid dispenser in to an operative position relative to the substrate and using the fluid dispenser to dispense a fluid on to the substrate,
wherein step (ii) comprises moving the fluid dispenser and tilting the substrate about at least one axis.

15. A method according to claim 14, wherein step (ii) comprises the step of tilting the substrate such that the region of the substrate onto which fluid is dispensed is at least approximately horizontal.

16. An method according to claim 14 in which the apparatus further comprises a pick-up device and the method comprises the additional step (iii) of using the pick-up device to place a component in a fluid dispensed onto the substrate.

17. A method according to claim 14 in which the apparatus further comprises an activation source and the method comprises the additional step (iv) of using the activation source to activate the fluid dispensed on to the substrate.

18. A method according to claim 17 wherein step (ii) comprises using the fluid dispenser to dispense an adhesive on to the substrate and step (iv) comprises using an activation source to cure the adhesive.

19. A method according to claim 17 wherein step (ii) comprises using the fluid dispenser to dispense a solder paste on to the substrate and step (iv) comprises using an activation source to melt the solder paste.

20. A method according to claim 17 in which the activation source is a microwave source and step (iv) comprises directing microwave radiation at the fluid.

21. A method according to claim 14 wherein step (ii) comprises tilting the substrate into a first orientation and then moving the fluid dispenser so as to dispense fluid on to a first region of the substrate.

22. A method according to claim 21 wherein step (ii) is repeated one or more times, wherein for each repetition of step (ii) the substrate is tilted into a further orientation and the fluid dispenser dispenses fluid on to a further region of the substrate.

23. A method according to claim 22, wherein at least one of step (iii) and step (iv) are performed between repetitions of step (ii), wherein step (iii) comprises using the pick-up device to place a component in a fluid dispensed on to the substrate, and step (iv) comprises using the activation source to activate the fluid dispensed on to the substrate.

24. A method according to claim 15 wherein step (i) comprises taking a non-planar substrate.
